(19) United States
(12) Patent Application Publication
(10) Pub. No.: US 2017/0161681 A1
(43) Pub. Date: Jun. 8, 2017

(54) SYSTEM AND METHOD FOR AUTOMATED POPULATION OF A PERSONAL PORTFOLIO OF PROJECTS ON A SOCIAL NETWORK

(71) Applicant: Shocase, Inc., San Francisco, CA (US)

(72) Inventors: Ronald P. Young, Mill Valley, CA (US); David Anthony Burgess, Menlo Park, CA (US); Bradley Nemer, San Carlos, CA (US); Peter Rugg, New York, NY (US)

(21) Appl. No.: 15/368,131

(22) Filed: Dec. 2, 2016

Related U.S. Application Data
(60) Provisional application No. 62/262,818, filed on Dec. 3, 2015.

(51) Int. Cl. G06Q 10/10; G06Q 50/00

(52) U.S. Cl. CPC G06Q 10/101; G06Q 50/01

(57) ABSTRACT

A method for use in populating a personal portfolio of projects of a member on a social network includes: registering, by a registration module, a candidate with the social network, the candidate, once registered, becoming the member; accessing stored assets associated with the member based on information provided by the member, the stored assets comprising work product corresponding to the member that is relevant to the member's online presence on the social network; building one or more projects by scanning and curating the stored assets associated with the member from at least one data source; and adding at least a subset of the projects to the personal portfolio of projects of the member.

### CROSS-REFERENCE TO RELATED APPLICATIONS

This Application claims the benefit of U.S. Provisional Patent Application Ser. No. 62/262,818, filed Dec. 3, 2015, entitled “System and Method for Autocuration of a Portfolio of Work to Populate a Social Network Profile,” which is hereby incorporated by reference herein in its entirety for all purposes.

This Application is also related to U.S. application Ser. No. 14/507,003, filed Oct. 6, 2014, entitled “System and Method to Provide Collaboration Tagging for Verification and Viral Adoption,” to U.S. application Ser. No. 14/626,012, filed Feb. 19, 2015, entitled “System and Method to Provide Pre-Populated Personal Profile in a Social Network,” and to U.S. application Ser. No. 15/057,371, filed Mar. 1, 2016, entitled “System and Method for Curation of Notable Work and Relating it to Involved Organizations and Individuals,” the disclosures of which are incorporated by reference herein in their entireties.

### FIELD OF THE INVENTION

The present invention applies generally to the electronic and computer arts, and more particularly relates to Internet-based methodologies and apparatus that drives social networking applications.

### BACKGROUND

Social networks are constructs (e.g., systems and/or structures) comprised of a set of social actors (e.g., individuals and/or organizations) and sets of relations describing social interactions between pairs of social actors. More particularly, social networks are generally self-organizing, evolving, and complex, such that a globally coherent pattern appears from the local interaction of the social actors that make up the system. Social networks permit users to become members and, as members, to utilize the system for socialization with other member users. A social network that primarily targets the work place and serves the business needs of people working in a specific business market vertical may be defined as a market network. This construct may be implemented as an Internet site, website, application, software or more, residing on a computer, smart phone, tablet or other user device, and may be published in whole or in part or in summary in the system.

There exists prior art in the nature of, and methods for the assisted generation and population of user-content in computer systems with varying degrees of input from the user. For example, methods are known which enable a user to fill out a number of search fields which can be used to retrieve data from a database, to use stored locators (e.g., universal resource locators or URLs) to point to online content, and to view online content as previews and store reference images from it along with locators.

It is also known to search for certain data or information. However, heretofore, there has been no reliable method or system to simplify and streamline the digital curation of a user's own data from a variety of disparate sources using his or her own provided location and credential information and then having his or her assets assembled so that he or she can further filter and/or edit those assets into an online portfolio on a market network.

### SUMMARY

Proposed is a method of speeding-up and simplifying the curation of a user's data from a variety of online and/or offline locations into a portfolio of projects within a social network and providing the user with the opportunity to discard or keep, and further edit those projects by adding relevant personal and collaborative information, including but not limited to identifying the type of project, his or her own role in a project, and important people who are associated with such project. The curation of the project is achieved with minimal effort from the user beyond providing a framework for the curation process and final decisions on the project content and form.

In accordance with an embodiment of the invention, a method for use in populating a personal portfolio of projects of a member on a social network includes: registering, by a registration module, a candidate with the social network, the candidate, once registered, becoming the member; accessing stored assets associated with the member based on information provided by the member, the stored assets comprising work product corresponding to the member that is relevant to the member's online presence on the social network; building one or more projects by scanning and curating the stored assets associated with the member from at least one data source; and adding at least a subset of the projects to the personal portfolio of projects of the member. The method may, in one or more embodiments, further include presenting to the member for review curated work product in the one or more projects, the member determining at least one action to take on each element of the curated work product.

In accordance with another embodiment of the invention, an apparatus for populating a personal portfolio of projects of a member on a social network includes memory and at least one processor coupled with the memory. The processor is configured: (i) to register a candidate with the social network, the candidate, once registered, becoming the member; (ii) to access stored assets associated with the member based on information provided by the member, the stored assets comprising work product corresponding to the member that is relevant to the member's online presence on the social network; (iii) to build one or more projects by scanning and curating the stored assets associated with the member from at least one data source; and (iv) to add at least a subset of the projects to the personal portfolio of projects of the member.

In accordance with yet another embodiment of the invention, a system for populating a personal portfolio of projects of a member on a social network includes a registration module, a user interface module and a curation module executing on the at least one hardware processor. The registration module is configured to register a candidate with the social network, the candidate, once registered, becoming the member. The user interface module is configured to present one or more data fields through which information is received from the member, the system accessing stored assets associated with the member based on the information received from the member, the stored assets comprising work product corresponding to the member that is relevant to the member's online presence on the social network. The curation module is configured to build one or more projects by scanning and curating the stored assets associated with the member from at least one data source, and to add at least a subset of the projects to the personal portfolio of projects of the member.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a flow diagram conceptually depicting at least a portion of an exemplary method for automatically populating a personal portfolio of projects on a social network, according to an embodiment of the present invention;

FIG. 2 is a block diagram conceptually depicting further details of an implementation of a first portion of the illustrative method shown in FIG. 1, according to an embodiment of the invention;

FIG. 3 is a block diagram conceptually depicting further details of an implementation of a second portion of the illustrative method shown in FIG. 1, according to an embodiment of the invention;

FIGS. 4 and 5A-5E depict an illustrative method for automatically populating a personal portfolio of projects on a social network, and corresponding exemplary web screen shots, respectively, according to an embodiment of the invention; and

FIG. 6 is a block diagram depicting at least a portion of an exemplary system suitable for implementing at least a portion of the illustrative method shown in FIG. 1, according to an embodiment of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of the present disclosure will be described herein in the context of illustrative methods and apparatus for use in speeding-up and simplifying the curation of a user's data from a variety of online and/or offline sources into a portfolio of projects within a social network (e.g., a market network) and for providing the user with an opportunity to discard, keep and/or further edit those projects in a manner which facilitates social networking applications. It is to be appreciated, however, that the specific apparatus and/or methods illustratively shown and described herein are to be considered exemplary rather than limiting. Moreover, it will become apparent to those skilled in the art given the teachings herein that numerous modifications can be made to the embodiments shown that are within the scope of the appended claims. That is, no limitations with respect to the embodiments shown and described herein are intended or should be inferred.

In computer and database systems, an efficient method of creating content within a user-profile and developing an online presence is important in a business environment. Because it can often take a while to populate a profile with pertinent data, an objective of embodiments of the invention is to register new users on a market network and to immediately give them an opportunity, during or shortly after an initial registration procedure (e.g., sign-up, login, etc.), to quickly and simply create a substantial online presence.

In particular, one or more embodiments of the invention provide a unique system that beneficially allows a user of a market network to better access his or her own projects and historical work product efficiently and speedily by pointing the system to locally and/or remotely stored information belonging to that user where techniques can be employed to curate that data into projects to be added to the user's new online portfolio of accomplishments.

This objective is achieved, according to one or more embodiments, using a method that greatly simplifies and accelerates the curation of the user's data from a variety of online and/or offline sources and presents that user with a plurality of ready-made project templates. These rapidly accessed projects can then be further edited—developed, titled, and tagged with relevant collaborators or other identification information. Online and offline locations are provided by the user during a sign-on, or other initial registration procedure, for example through a sequence of data entry queries, and fields are provided for the user to input location information along with any relevant sign-on or other access credentials for those locations (e.g., username and password).

Digital curation is applied to interaction with social media often in a timeline sequence of reports, pictures or other postings. One or more embodiments of the present invention curates different information in a unique and beneficial way, compiling digital assets such as, for example, images, documents, sound files, web links and movie files in a more compelling portfolio of work accomplishments, sports achievements, entertainment presentations, or other endeavors appropriate to the market network. It establishes, maintains and adds value to repositories of digital data for present and future use. With embodiments of the invention, users can utilize digital curation to improve the quality of data within their operational and strategic processes and specific creation of a robust portfolio of accomplishments.

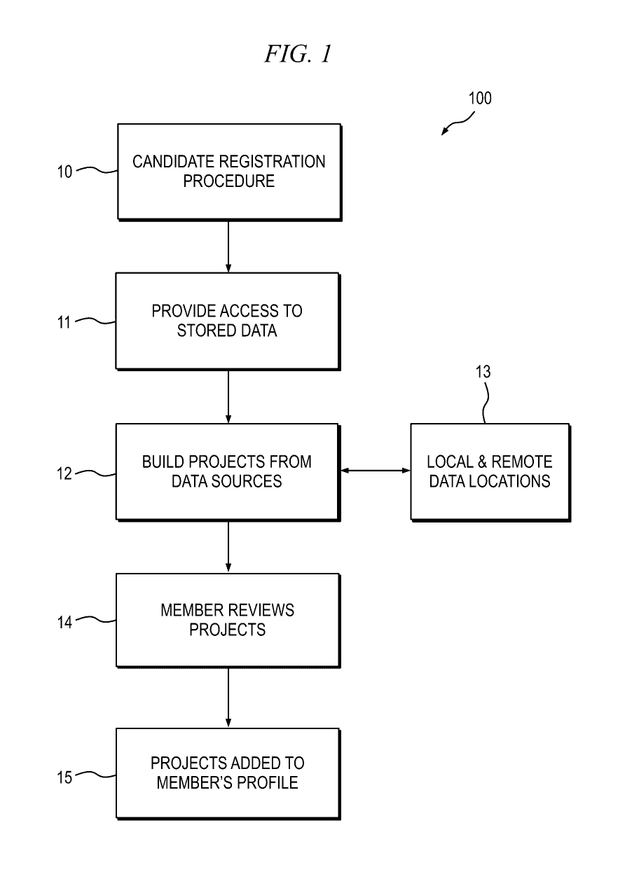

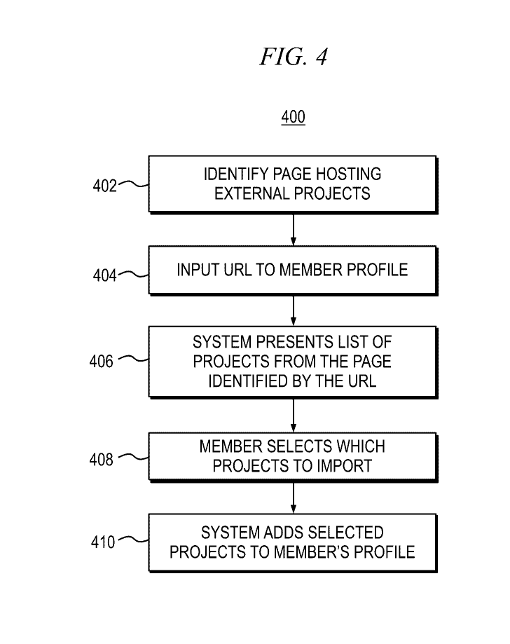

FIG. 1 is a flow diagram conceptually depicting at least a portion of an exemplary method 100 for automatically populating a personal portfolio of projects on a social network, according to an embodiment of the invention. With reference to FIG. 1, the method 100 begins with a candidate registration procedure in step 10, wherein a new user signs-up to the social network. As used herein, the term “user” is intended to refer to a general social network user/operator, and the term “candidate” is intended to refer to a potential member of a system in accordance with one or embodiments of the invention; a candidate, once registered with the system, becomes a member of the system. The registration procedure 10, in one or more embodiments, is implemented using a registration module executing on at least one hardware processor (see FIG. 4).

During step 10, a user interface module executing on at least one hardware processor may present one or more data fields which afford the registered member an opportunity to enter information that provides the system (e.g., a processor on which the method 100 is running) with access to stored data, in step 11, associated with the member, including the location(s) of certain personal data, information, projects, or other work product or accomplishments which are suitable for curating into the social network as elements to be stored in the member's online personal or professional profile. Part of the registration process may involve, in one or more embodiments, a candidate providing prescribed identifying information, such as, for example, name, address and telephone number, email address, etc. The member may select a unique username and password for accessing the system, and the system may store such username and associated password so that the member can log in to the system without the need to re-enter his or her personal or other information.

After submitting information on where a portfolio is stored, the types of files, and the access credentials (step 11), the method 100 curates the stored data to build projects, in step 12, from the stored data sources which may be relevant to that member's online presence on the social network. Step 12 may, in one or more embodiments, be implemented using a curation module executing on said at least one hardware processor. The data sources may comprise remote and/or local data locations 13, such as, for example, online sources coupled with the social network (e.g., video sites) and offline sources (e.g., the member's local computer hard drive, library reference or archive source), respectively. In one or more embodiments, the member can request that each location of data curation be rigorous or scant, as required in the scanning and curating process. In step 14, curated work product is presented to the member for review, and each element of work can be accepted as relevant or rejected as inappropriate, described, prioritized, labeled, and/or cataloged into sub-files, among other actions. The member is also given an opportunity to further edit any project description, adding his or her own role, any other team collaborator(s), or other relevant descriptive information.

Projects are then added to the member's profile in step 15. In another embodiment, each element of work is evaluated by the member and associated with a prescribed template for the data in the project. The associated template is designed to prompt the member to provide information on the project that permits proper classification, tagging and cataloging with other similar types of work product. In yet another embodiment, the system will prompt the member to scroll through the project in order to select and crop one or more representative images, titles or other indicia that can be used in a thumbnail icon representing the project. It is to be understood that embodiments of the invention contemplate various other approaches to classify and represent information and/or work product associated with a given project.

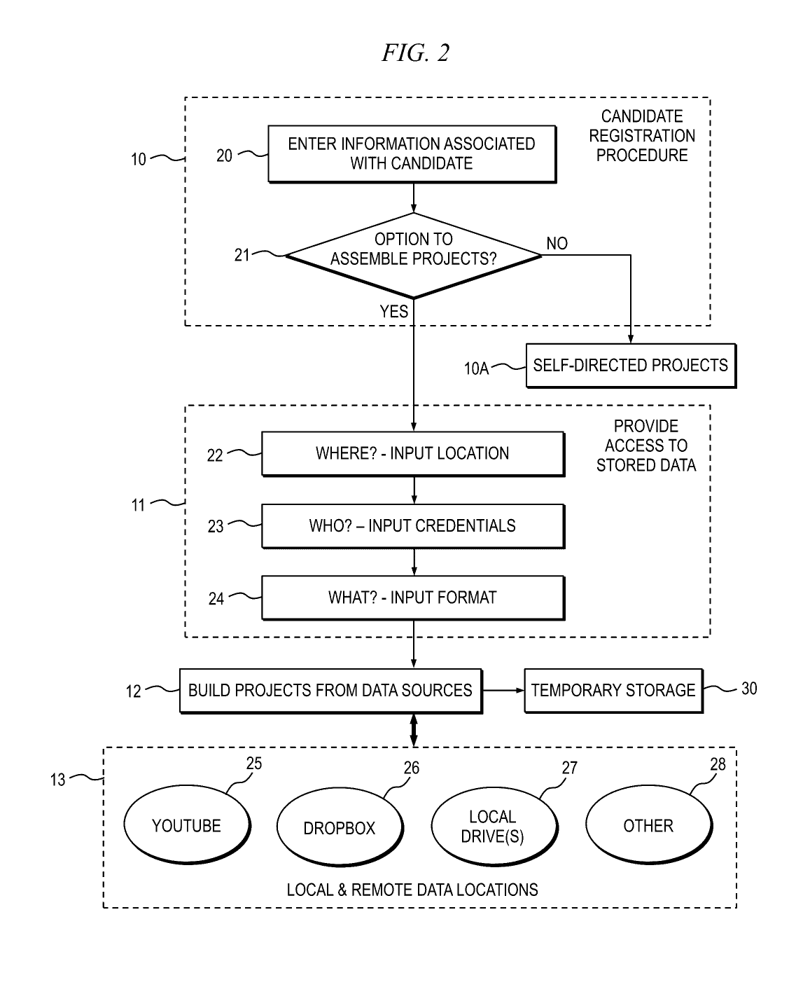

FIG. 2 is a block diagram conceptually depicting further details of an implementation of a first portion of the illustrative method 100 shown in FIG. 1, according to an embodiment of the invention. Specifically, FIG. 2 presents a flowchart that further details the initial candidate registration procedure (step 10) and data input procedures (steps 11 and 12). With reference now to FIG. 2, the candidate registration procedure 10 is further divided into at least two sub-procedures. In one or more embodiments, in step 20, the candidate enters information uniquely identifying him or her to the system, which may include, for example, a username, password, and/or other information. Once registered with the system, the candidate becomes a member of the system, as previously stated. This identifying information may be stored by the system so that the member does not need to re-enter all information in subsequent execution of the method 100.

Next, in step 21, the member is presented with an option to assemble projects. By way of example only, in one or more embodiments, the member is presented with a prompt asking whether he or she would like automated assembly of his or her portfolio. Selecting “yes,” such as by placing a mouse cursor over an appropriate option selection button displayed by a user interface (e.g., home page) of the system, will present a group of data entry fields or blocks for enabling the system to access the stored data in step 11. Selecting “no” will allow the member to manually assemble projects in a self-directed manner in step 10A. In this manner, the system provides the member with an opportunity to opt out of automated project assembly.

In the illustrative embodiment shown in FIG. 2, providing access to the member's stored data in step 11 comprises requesting the locations, both online and offline, where the member's projects and work product are stored in step 22. Such location information may be input in the form of URLs, links or other identifying data. The member is also prompted to provide sign-on credentials (e.g., password, username, etc.) in step 23, for those sites that require such credentials for accessing data in the corresponding stored location(s). Optionally, the member may be requested to enter the input format in step 24, such as, for example, .PDF, .MOV, .MP3 files, etc., specifying the file type. From this point the methodology embedded in the system looks in first one location, deploys the entry credentials, if required, and searches for data and assets associated with the member. When found, the data and access links to the assets are stored in a temporary storage location 30 (e.g., a database) while the system repeats the above actions of locating the data 22, accessing the data at the specified location with the supplied credentials 23, and in the specified format 24, and acquiring further data and assets.

The system methodology searches in each specified location for each type of data and asset, and builds projects from the accessed data in step 12 for storage in the temporary storage location 30. The project, which in one or more embodiments is stored as lists of access locations, assembles a portfolio of projects from the provided data sources in temporary storage 30, accessing the local and/or remote data locations 13. The local and remote locations 13 can include, but are not limited to, video sites such as Vimeo® (a registered trademark of Vimeo, Inc.) or YouTube® (a registered trademark of Google Inc.), 25, cloud storage sites such as iCloud® (a registered trademark of Apple, Inc.), Box or Dropbox® (a registered trademark of Dropbox, Inc.), 26, the member's own local drive, 27, which may comprise a hard-drive or removable drive (e.g., flash drive), and/or other storage media or sites, 28, one of which may be the market network itself. The bold two-way arrow between the search and building of the database (in step 12) and the sources of data 13 is intended to represent the iterative nature of the process of generating a full and complete database of the member's desired data and assets.

In one or more embodiments, the system uses at least one of the following methods to access the member's stored record of accomplishments: URL; pin it/get it locator; personal file locator and credential; and link to, or embedded, website with access credentials.

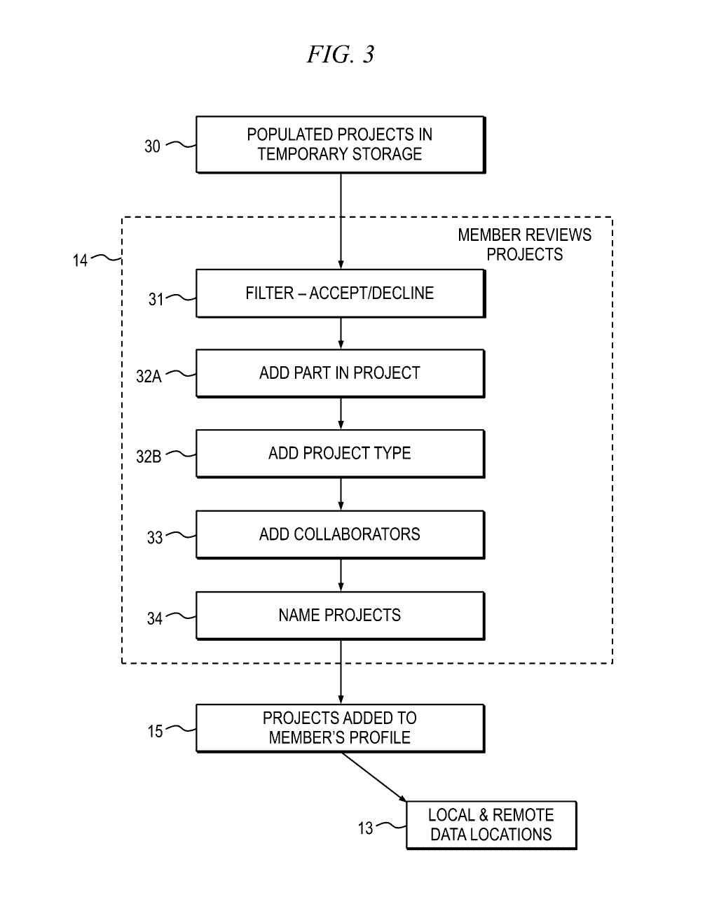

FIG. 3 is a block diagram conceptually depicting further details of an implementation of a second portion of the illustrative method 100 shown in FIG. 1, according to an embodiment of the invention. More particularly, FIG. 3 presents an additional flowchart showing a further breakdown and detailed view of the returned projects and subsequent filtering, compiling and editing options. The now populated projects in temporary storage location 30 from the curation process are presented to the member to be reviewed in step 14. In this illustrative embodiment, the member review procedure in step 14 involves several possible options, one of which is to determine whether to accept the project as suitable for use in the member's profile or to reject the project as inappropriate for the profile in step 31. The member can add his or her own position regarding what his or her role was on the project in step 32A, and add the project type in step 32B. By way of example only and without limitation, for a market network directed to entertainment, project types may include film, documentary, play, show, concert, or performance; if directed to, for example, sports, the events and accomplishments might be a game, heat, match, meet or championship.

In step 33, the system queries the member for associations with as many of the collaborating team colleagues, referred to herein as collaborators, as can be identified, along with their respective positions in the project. Collaborators can later be contacted through automated message templates, or an alternative communication methodology, to refine or embellish their role in the project and to encourage others to submit their contributions through their joining of the market network. This confirmed collaboration performs a project verification function enhancing credibility and value on the site. In step 34, the member can supply the project with a name and title page, for example via an interface which allows the member to easily scroll through different parts of the project, focus on a particular area, home-in on a particular image and has the ability to resize and edit or otherwise enhance an image to utilize as a front page, title or subtitle that displays access to the full project. The project(s) can be added to the member's profile as part of step 15, allocated to portfolios or sub-portfolios with a range of available cataloging alternatives. In one or more embodiments, the title page stays with the project (such as if it is used in outbound marketing email) along with locators to external files, which may be stored in local and/or remote data locations 13, all of which is seamless to the user; that is, the filing with associated tags and references may be done behind the scenes in the social network. The social network, in this case, activates a warehouse of locators and precisely locates the files with available titles, sub-titles, representative images, identification tagging and the like. If any of the files are located behind restricted access credential input, then the method 100 deployed in the system utilizes those credentials to gain access for presentation (e.g., display) to any user of the social network system.

In another embodiment of the invention, the external files are both linked and copied to the market network's repository, so that:
a copy is stored on the market network in case the external file is deleted or cannot be accessed (e.g., because the access credentials have changed); and
a link is stored on the market network in case the external file is updated, and the corresponding market network repository file can be updated, either automatically or with manual approval.

In one or more embodiments, the automated curation system for bringing a significant amount of work product into the social network system reduces time, file sizes, and complexity for the utility of the social network for new users.

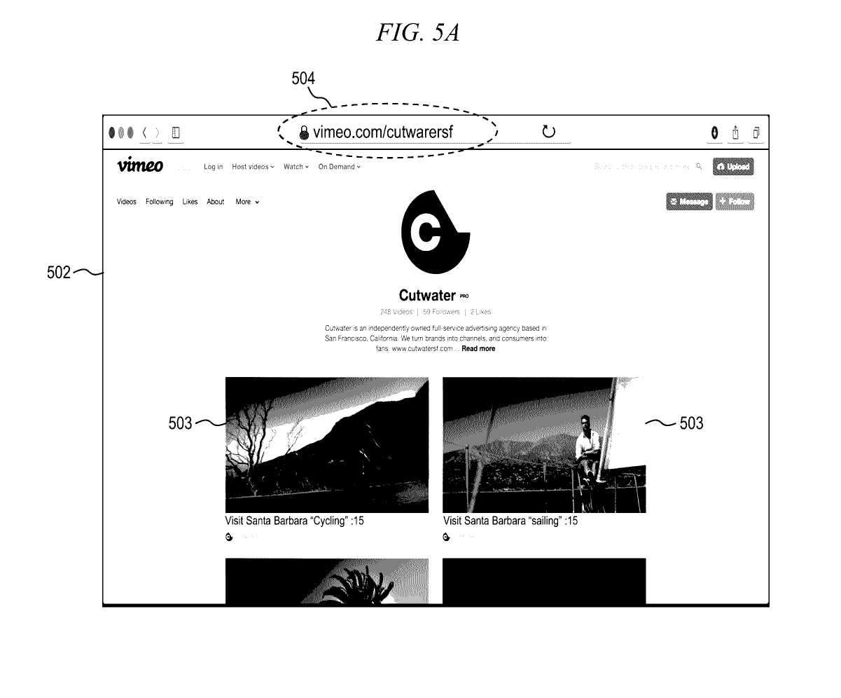

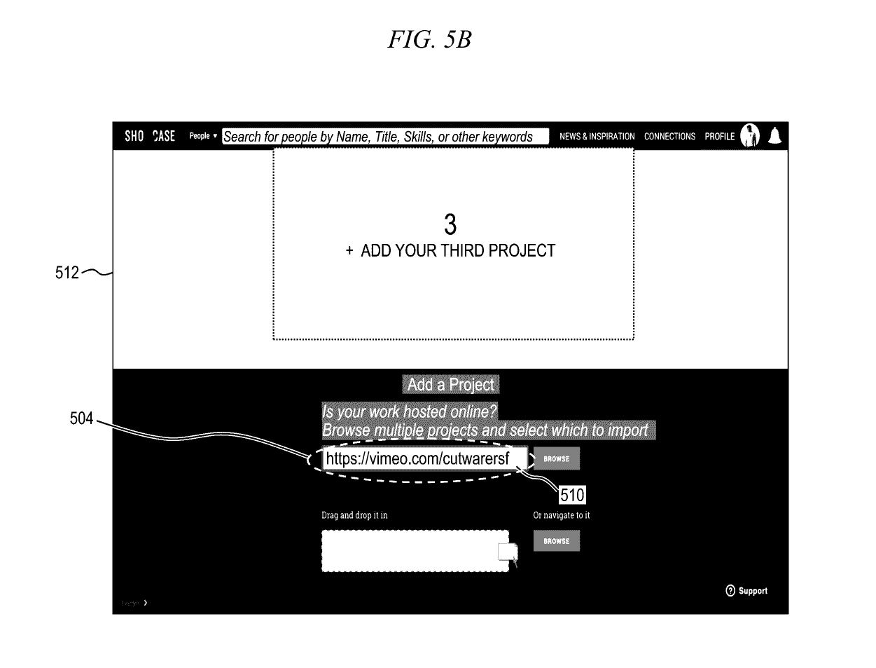

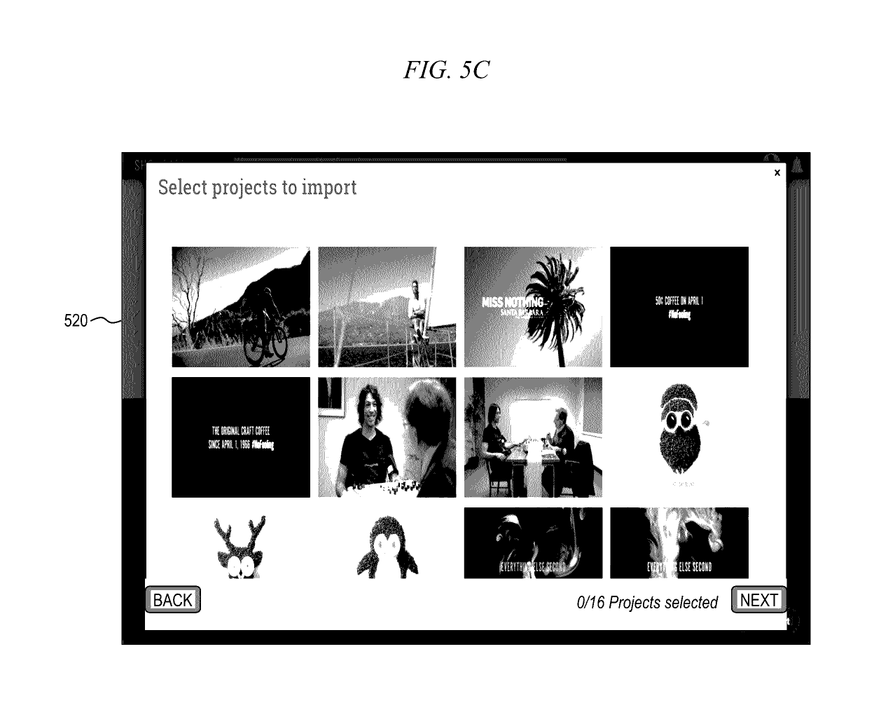

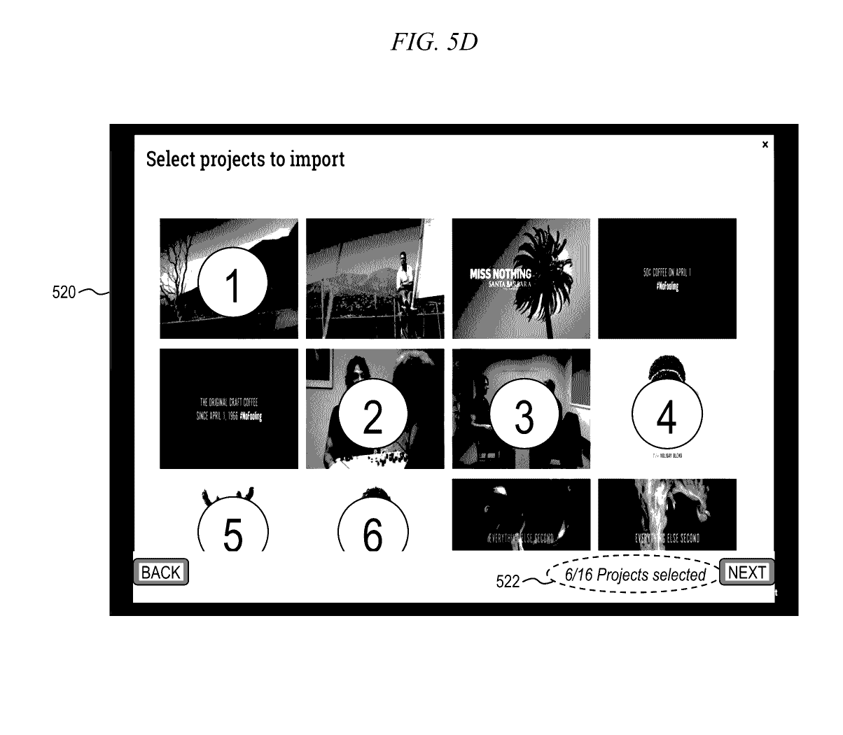

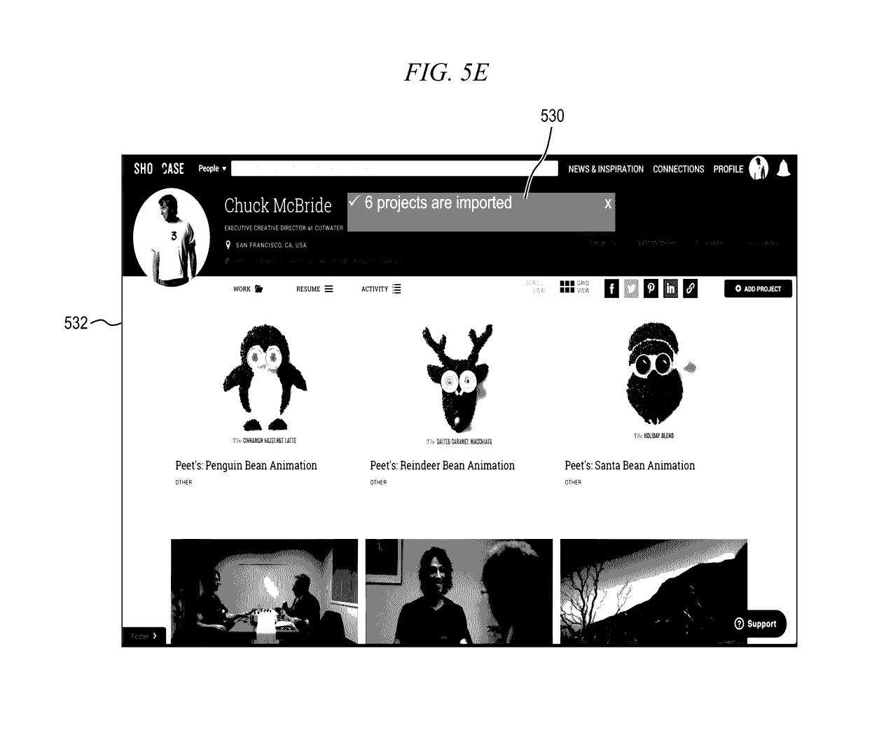

By way of example only and without limitation, FIGS. 4 through 5E depict an illustrative method 400 for automatically populating a personal portfolio of projects on a social network, and corresponding web screen shots, respectively, according to an embodiment of the invention. With reference to FIG. 4, once a candidate user has been registered with the system and becomes a member, the method 400 identifies at least one web page hosting one or more projects associated with the member in step 402. As shown in FIG. 5A, the member navigates to an external web page 502 hosting his or her projects 503. The member then copies the URL address 504 corresponding to that web page 502.

The member inputs the URL address 504 into his or her profile in step 404, such as by pasting the URL address corresponding to the web page 502 into a designated field (e.g., input box) 510 on a member profile page 512 on the system, as shown in FIG. 5B. The system then presents a list of projects on the web page identified by the selected URL address from which the member can select in step 406. In one or more embodiments, step 406 includes the system examining the source and/or structure of the URL to determine, for example, whether the system supports importing from this site (e.g., YouTube, Vimeo, etc.), whether the system supports the file type hosted on the site, whether the URL refers to one or multiple projects, and/or other characteristics as may be established by the system or the member. The system preferably downloads a cover image, or other identifying indicia (e.g., filename, video clip, etc.), of each project on the external page identified by the selected URL and presents a web page 520 including a list of projects available for import, as shown in FIG. 5C.

In step 408, the member selects one or more projects to import into his or her profile. In one or more embodiments, the system provides an indication of which project(s) are selected, such as, for example, by placing a number or other identifier over an image of the project, as shown in FIG. 5D. In one or more embodiments, an indication 522 of the number of projects selected may be displayed. The system then adds the selected project(s) to the member's profile in step 410, including importing relevant metadata such as, for example, title and project type. In one or more embodiments, the system presents an acknowledgment 530 on the member's profile page 532 indicating that that the selected projects were successfully imported, as shown in FIG. 5E. Once the projects have been imported into the member's profile, the member can edit each project in a conventional manner.

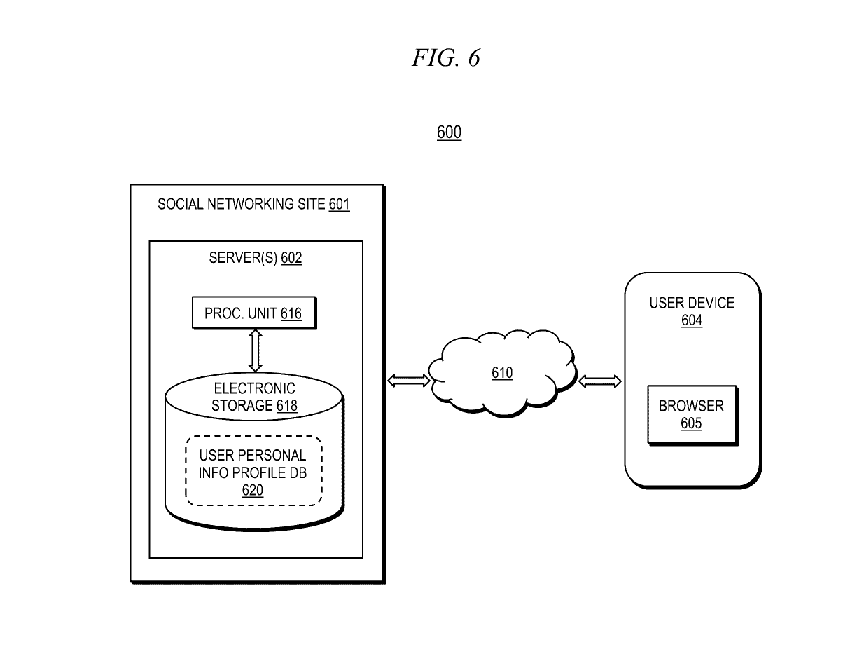

FIG. 6 is a block diagram depicting at least a portion of an exemplary system 600 suitable for implementing at least a portion of the illustrative method shown in FIG. 1, according to an embodiment of the invention. In this illustrative embodiment, the system 600 is preferably an Internet-accessible social network site system. The platform of system 600 includes a social networking website 601 that is hosted by a server (or servers) 602 which are configured to communicate with, and process information from, one or more remotely-situated user communication devices 604 a via a communication facility, such as, for example, the Internet 610. The user communication device 604 may include a processor running a browser program 605 (e.g., Internet Explorer) configured to interface with the Internet 610.

The server(s) 602 may embody one or more computing devices incorporating hardware components, operating systems, and programming languages that may be familiar to those skilled in the art in order to implement the processing as described herein. The computing devices may include one or more memory storage devices, such as, for example, electronic storage device(s) 618, as well as one or more physical processing units 616 programmed with one or more computer program instructions to perform the functionality of the social networking website 601, in addition to other components. As such, the processing unit(s) 616 may embody one or more of a digital processor, analog processor, digital circuitry designed to process information, analog circuitry designed to process information, a state machine, and/or other mechanisms for electronically processing information. In some implementations, the processing unit(s) 616 may include a plurality of processors that are physically located within the same computing device or may represent processing functionality of a plurality of devices operating in coordination, such as a distributed processing system.

The computing devices may also include one or more communication modules configured to establish the communication and accommodate the exchange of information between social networking website 601 and the user device(s) 604 and/or other computing platforms via the communication facility, such as, the Internet 610. The computing devices may further include a plurality of hardware, software, and/or firmware components operating in conjunction with one another to provide the functionality attributed herein to server(s) 602. For example, the computing devices may be implemented by a cloud of computing platforms communicating and operating together.

As noted above, server(s) 602 may include memory storage devices, such as, electronic storage device(s) 618, which may store software algorithms, information generated by processing units 616, information received from other server(s) 602, information received from the remote user(s) 604, information received from other computing platforms, or other information that enables the server(s) 602 to function as described herein. In particular, with regard to the server(s) 602 of the social networking website 601, electronic storage device(s) 618 may be configured to store information related to the user(s) 604, such as, for example, user-guided, pre-populated personal information profiles in database(s) 620. The database(s) 620 may include, or interface with, for example, an Oracle® relational database (Oracle is a registered trademark of Oracle International Corporation, Redwood City, California), Informix®, DB2® (Database 2) (Informix® and DB2® are registered trademarks of International Business Machines Corporation, Armonk, N.Y.), or other data storage, including file-based, or query formats, platforms, or resources such as OLAP (On Line Analytical Processing), SQL (Structured Query Language), a SAN (Storage Area Network), Microsoft® Access® (Microsoft®, Access®, and Microsoft Access® are registered trademarks of Microsoft Corporation, Redmond, Wash.), or others may also be used, incorporated, or accessed. It will be appreciated that database(s) 620 may comprise one or more such databases that reside in one or more physical devices and in one or more physical locations. The database(s) 620 may be configured to store a plurality of types of data and/or files and associated data or file descriptions, administrative information, or any other data.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for use in populating a personal portfolio of projects of a member on a social network, the method comprising:
registering, by a registration module, a candidate with the social network, the candidate, once registered, becoming the member;
accessing stored assets associated with the member based on information provided by the member, the stored assets comprising work product corresponding to the member that is relevant to the member's online presence on the social network;
building one or more projects by scanning and curating the stored assets associated with the member from at least one data source; and
adding at least a subset of the projects to the personal portfolio of projects of the member.

2. The method of claim 1, further comprising presenting to the member for review curated work product in the one or more projects, the member determining at least one action to take on each element of the curated work product.

3. The method of claim 1, wherein the at least one data source comprises at least one of remote data sources and local data sources.

4. The method of claim 3, wherein at least a subset of the remote data sources comprises an online source connected with the social network.

5. The method of claim 1, wherein registering the candidate with the social network comprises:
entering information associated with the candidate; and
presenting the member with an option to one of manually assemble and automatically assemble projects added to the personal portfolio of projects of the member.

6. The method of claim 5, wherein automatically assembling projects comprises prompting the member to enter information relating to at least one location of where the member's projects and work product are stored.

7. The method of claim 6, wherein automatically assembling projects comprises prompting the member to enter information relating to sign-on credentials for accessing the at least one location where the member's projects and work product are stored.

8. The method of claim 6, wherein automatically assembling projects comprises prompting the member to enter information relating to a format of data stored at the at least one location.

9. The method of claim 6, wherein prompting the member to enter information relating to at least one location of where the member's projects and work product are stored comprises entering a uniform resource locator (URL) address corresponding to the at least one location.

10. The method of claim 7, further comprising:
repeating the steps of locating where the member's projects and work product are stored and accessing data at specified locations using the supplied sign-on credentials; and
storing the data and access links corresponding to the stored assets associated with the member.

11. The method of claim 2, wherein presenting the curated work product of the member for review comprises at least one of: accepting the project as suitable for use in the personal portfolio; rejecting the project as inappropriate for the personal portfolio; adding at least one role of the member in the project; adding a project type; adding one or more associations with identified collaborators; and adding a project name.

12. An apparatus for populating a personal portfolio of projects of a member on a social network, the apparatus comprising:
memory; and
at least one processor coupled with the memory, the at least one processor configured: (i) to register a candidate with the social network, the candidate, once registered, becoming the member; (ii) to access stored assets associated with the member based on information provided by the member, the stored assets comprising work product corresponding to the member that is relevant to the member's online presence on the social network; (iii) to build one or more projects by scanning and curating the stored assets associated with the member from at least one data source; and (iv) to add at least a subset of the projects to the personal portfolio of projects of the member.

13. The apparatus of claim 12, wherein the at least one processor is further configured to present to the member for review curated work product in the one or more projects, the member determining at least one action to take on each element of the curated work product.

14. The apparatus of claim 12, wherein the at least one data source comprises at least one of remote data sources and local data sources.

15. The apparatus of claim 14, wherein at least a subset of the remote data sources comprises an online source connected with the social network.

16. The apparatus of claim 12, wherein in registering the candidate to become the member the at least one processor is further configured to receive information regarding the candidate and to present the member with an option to one of manually assemble and automatically assemble projects added to the personal portfolio of projects of the member.

17. The apparatus of claim 16, wherein in automatically assembling projects the at least one processor is configured to prompt the member to enter information relating to at least one location of where the member's projects and work product are stored.

18. The apparatus of claim 17, wherein in automatically assembling projects the at least one processor is configured to prompt the member to enter information relating to sign-on credentials for accessing the at least one location where the member's projects and work product are stored.

19. The apparatus of claim 18, wherein the at least one processor is further configured:
to repeat the steps of locating where the member's projects and work product are stored and accessing data at specified locations using the supplied sign-on credentials; and
to store the data and access links corresponding to the stored assets associated with the member.

20. A system for populating a personal portfolio of projects of a member on a social network, the system comprising:
a registration module executing on at least one hardware processor, the registration module being configured to register a candidate with the social network, the candidate, once registered, becoming the member;
a user interface module executing on the at least one hardware processor, the user interface module being configured to present one or more data fields through which information is received from the member, the system accessing stored assets associated with the member based on the information received from the member, the stored assets comprising work product corresponding to the member that is relevant to the member's online presence on the social network; and
a curation module executing on the at least one hardware processor, the curation module being configured to build one or more projects by scanning and curating the stored assets associated with the member from at least one data source, and to add at least a subset of the projects to the personal portfolio of projects of the member.

21. The system of claim 20, the curation module being configured to present to the member for review curated work product in the one or more projects, and to receive from the member at least one action to take on each element of the curated work product.
